(19) United States
(12) Patent Application Publication
(10) Pub. No.: US 2011/0103276 A1
(43) Pub. Date: May 5, 2011

(54) METHOD FOR TRANSMITTING UNIVERSAL SERIAL BUS DATA AND APPARATUS USING THE SAME

(75) Inventor: Wu Yu CHUANG, Hsinchu County (TW)

(73) Assignee: RALINK TECHNOLOGY CORPORATION, HSINCHU COUNTY (TW)

(21) Appl. No.: 12/910,341

(22) Filed: Oct. 22, 2010

(30) Foreign Application Priority Data
Nov. 2, 2009 (TW) 098137064

(51) Int. Cl. H04B 7/00; H04L 1/18; G06F 11/14

(52) U.S. Cl. 370/310; 714/749; 714/E11.113

(57) ABSTRACT

The present invention discloses a universal serial bus data transmission method. The universal serial bus data transmission method comprises the steps of: obtaining a time interval in accordance with a size of a buffer and a transfer rate of a wireless communication chip; sending data to the wireless communication chip; and, if the wireless communication chip responds with a negative acknowledge packet, re-sending the data to the wireless communication chip after the time interval.

### BACKGROUND OF THE INVENTION

1. Field of the Invention

The present invention relates to a method for transmitting data, and more particularly, to a method for transmitting universal serial bus data and an apparatus using the same.

2. Description of the Related Art

Wireless local area network (WLAN) technology is now widely used in various applications. Numerous organizations devote extensive resources to research seeking improvements in WLAN data communication quality. With the continuing increase in the required bandwidth and packet throughput of household internet, campus internet and enterprise internet, the performance of packet transmission and the development of packet processing techniques are drawing more and more attention.

FIG. 1 shows a block diagram of a wireless communication driver sending data to a wireless communication chip. To transfer data from a wireless communication driver 101 to a wireless communication chip 106, the wireless communication driver 101 needs to send the data to a host controller driver 103 through a universal serial bus (USB) driver 102. Subsequently, the host controller driver 103 controls a USB chip 104 for sending the data to the wireless communication chip 106 through a USB bus 105. To receive data from the wireless communication chip 106, the wireless communication driver 101 needs to send a request packet to the host controller driver 103 through the USB driver 102. Subsequently, the host controller driver 103 controls the USB chip 104 for sending the request packet to the wireless communication chip 106 through the USB bus 105. After receiving the request packet, the wireless communication chip 106 determines whether a receiving buffer 108 stores received data. If YES, the wireless communication chip 106 sends the received data to the host controller driver 103 through the USB bus 105. Subsequently, the host controller driver 103 sends the received data to the wireless communication driver 101 through the USB driver 102. However, both processes of sending to and receiving from the wireless communication chip 106 require data to be passed through the USB bus 105. If the host controller driver 103 controls the USB chip 104 for sending data to the wireless communication chip 106, the data sent from the wireless communication chip 106 cannot be received at the same time. During periods of poor wireless communication signal, the sending operation for the data to be sent in a transmitting buffer 107 may be postponed. Therefore, if the transmitting buffer 107 is full or the space of the transmitting buffer 107 is insufficient to store more data while the host controller driver 103 controls the USB chip 104 for sending data to the wireless communication chip 106, the wireless communication chip 106 responds with a negative acknowledge (NAK) packet. After the host controller driver 103 receives the NAK packet, it sends packet internet grope (PING) packets continuously until the wireless communication chip 106 responds with an acknowledge (ACK) packet. Next, the host controller driver 103 starts to send the data to the wireless communication chip 106.

FIG. 2 shows a timing chart for sending data. As shown in FIG. 2, during the period of t1 to t2, a large quantity of NAK packets are sent to the host controller driver 103. During this period, the data throughput of the receiving buffer 108 is decreased dramatically. In addition, the data stored in the receiving buffer 108 might be overwritten, which can affect the entire data throughput.

### SUMMARY OF THE INVENTION

The method and apparatus of the present disclosure for transmitting USB data includes obtaining a time interval in accordance with a buffer size and a transfer rate of a wireless communication chip. After data is sent to the wireless communication chip, if the wireless communication chip responds with a negative acknowledge packet, the data is re-sent to the wireless communication chip after the time interval. In addition, during the time interval, if a receiving buffer stores received data, the received data stored in the receiving buffer is received through the wireless communication chip, so as to increase data throughput.

One embodiment of the present invention discloses a method for transmitting universal serial bus (USB) data. The method comprises the steps of: obtaining a time interval in accordance with a size of a buffer and to a transfer rate of a wireless communication chip; sending data to the wireless communication chip; and, if the wireless communication chip responds with a negative acknowledge packet, re-sending the data to the wireless communication chip.

Another embodiment of the invention discloses an apparatus for transmitting USB data. The apparatus comprises a wireless communication chip, a calculating unit, a receiving unit, a determining unit and a transmitting unit. The wireless communication chip is configured to send at least one negative acknowledge packet, at least one acknowledge packet or at least one received data, or to receive at least one data to be sent. The calculating unit is configured to obtain at least one time interval in accordance with a size of a buffer and a transfer rate of a wireless communication chip. The receiving unit is configured to receive the at least one negative acknowledge packet, the at least one acknowledge packet and the at least one received data, which are sent by the wireless communication chip. The determining unit is configured to determine whether the receiving unit has received the at least one negative acknowledge packet or the at least one acknowledge packet. The transmitting unit is configured to send the at least one data to be sent to the wireless communication chip, or send at least one packet internet grope (PING) packet or the at least one data to be sent to the wireless communication chip in accordance with a determination result of the determining unit.

The foregoing has outlined rather broadly the features of the present disclosure in order that the detailed description of the disclosure that follows may be better understood. Additional features and advantages of the disclosure will be described hereinafter, which form the subject of the claims of the invention. It should be appreciated by those skilled in the art that the conception and specific embodiment disclosed may be readily utilized as a basis for modifying or designing other structures or processes for carrying out the same purposes as those of the present disclosure. It should also be realized by those skilled in the art that such equivalent constructions do not depart from the spirit and scope of the invention as set forth in the appended claims.

### BRIEF DESCRIPTION OF THE DRAWINGS

The accompanying drawings illustrate several embodiments of the invention and, together with the description, serve to explain the principles of the invention. Those skilled in the art will recognize that the particular embodiments illustrated in the drawings are merely exemplary, and are not intended to limit the scope of the present invention.

FIG. 1 shows a block diagram for a wireless communication driver sending data to a wireless communication chip;

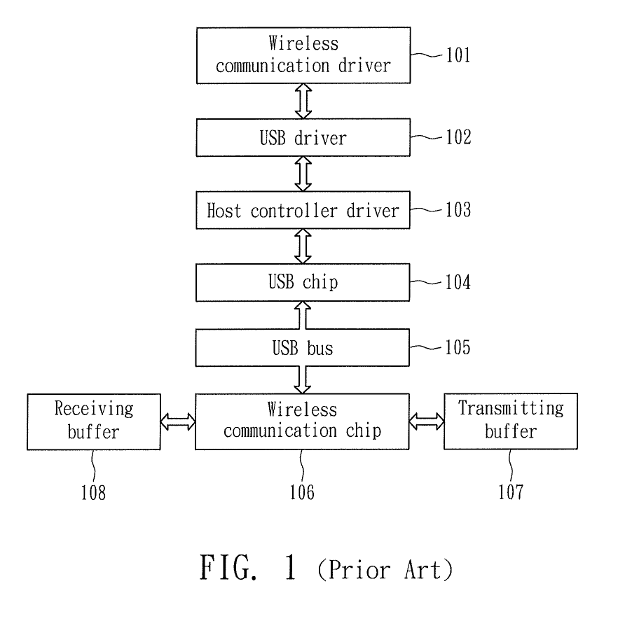

FIG. 2 shows a timing chart for sending data;

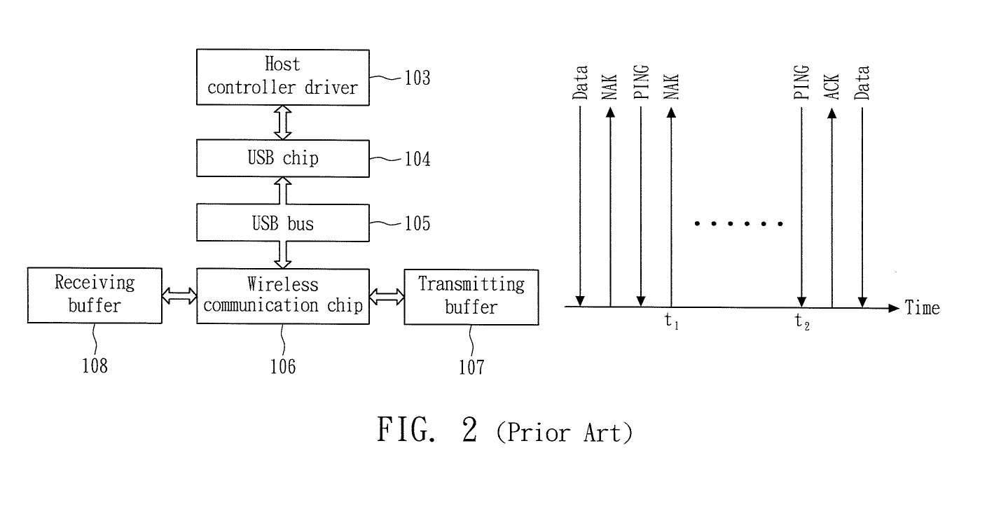

FIG. 3 shows a flowchart of a method for transmitting universal serial bus (USB) data in accordance with an exemplary embodiment of the present disclosure; and

FIG. 4 shows a block diagram of an apparatus for transmitting USB data in accordance with another exemplary embodiment of the present disclosure.

### PREFERRED EMBODIMENT OF THE PRESENT INVENTION

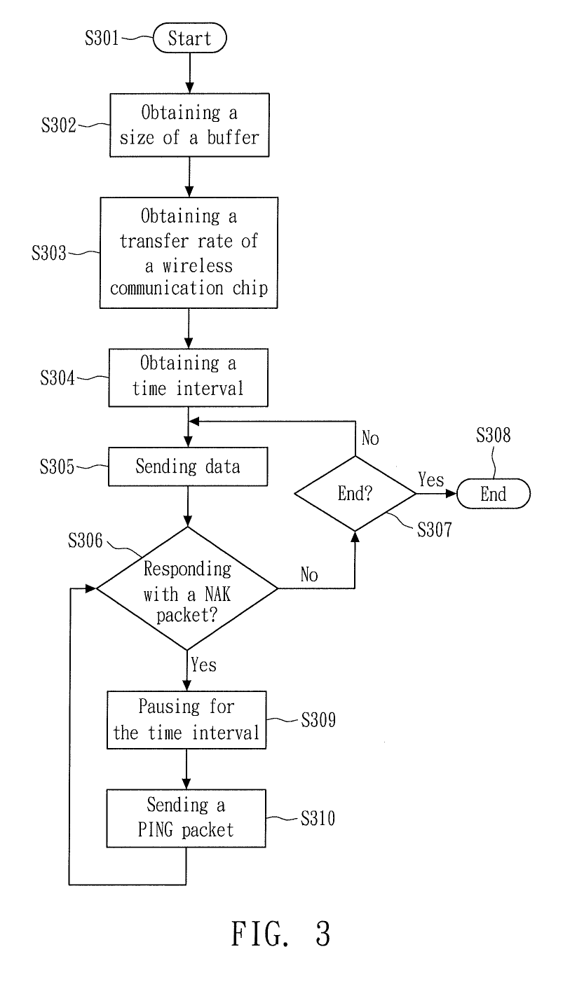

FIG. 3 shows a flowchart of a method for transmitting universal serial bus (USB) data in accordance with an exemplary embodiment of the present disclosure. In step S301, the procedure of the exemplary embodiment is activated. In step S302, a size of a buffer is obtained. In accordance with an exemplary embodiment of the present disclosure, the buffer, for example, is a transmitting buffer. The size of the transmitting buffer, for example, is 23K byte. However, the disclosure should not be limited to the embodiment. In step S303, a transfer rate of a wireless communication chip is obtained. The transfer rate of the wireless communication chip, for example, is 150M bit/s. However, the disclosure should not be limited to the embodiment. In step S304, a time interval is obtained in accordance with the size of the transmitting buffer and the transfer rate of the wireless communication chip. In accordance with an exemplary embodiment of the present disclosure, a software/hardware designer determines that the wireless communication chip sends 23K byte in 1.2 ms under an ideal condition in accordance with the size (23K byte) of the transmitting buffer and the transfer rate (150M bit/s) of the wireless communication chip. Therefore, the time interval of 1.2 ms is obtained in step S304. However, the disclosure should not be limited to the embodiment. The software/hardware designer can also use different time intervals in accordance with the communication quality of the environment. For example, the software/hardware designer estimates a duration for the wireless communication chip to send 20K byte data, and the duration is then used as a time interval. In step S305, data to be sent is sent to the wireless communication chip, wherein the data to be sent is sent to the wireless communication chip through a USB chip and a USB bus. Step S306 determines whether the wireless communication chip has responded with a negative acknowledge packet. If NO, Step S307 determines whether the procedure is ended. If YES, the procedure is ended in step S308. If NO, the next data to be sent is sent in step S305.

In step S306, if a negative acknowledge packet is sent by the wireless communication chip, the process is paused for a time interval. In this embodiment, the process is paused for 1.2 ms. During the time interval, if a receiving buffer has stored received data, the received data stored in the receiving buffer is received through the wireless communication chip. After pausing for 1.2 ms, in step S310 a packet internet grope (PING) packet is sent to the wireless communication chip through the USB chip and the USB bus. In step S306, it is determined whether the wireless communication chip has responded with a negative acknowledge packet. If the wireless communication chip has responded with a negative acknowledge packet, steps S307 and S305 are performed. If a user would like to terminate the procedure, the procedure is ended in step S308. If the wireless communication chip has responded with a negative acknowledge packet, steps S309 and S310 are repeated.

In addition to the above-mentioned method for transmitting USB data, an apparatus for transmitting USB data in accordance with another embodiment is described as follows to enable those skilled in the art to practice the present invention.

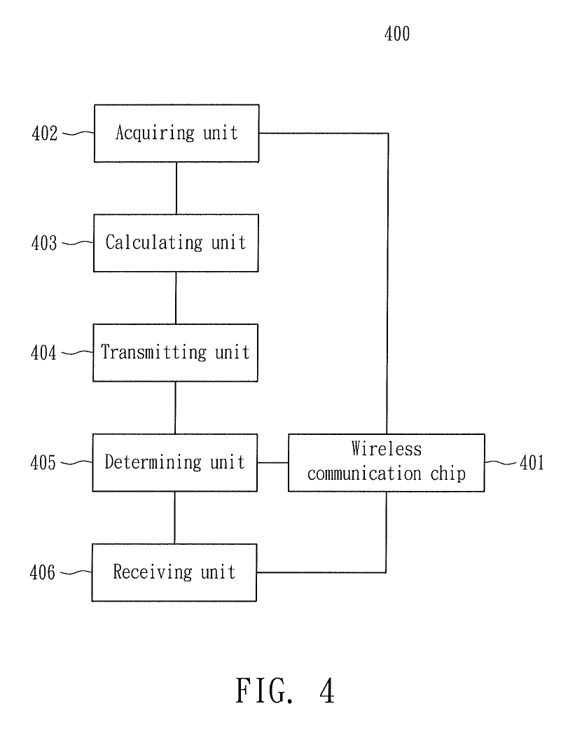

FIG. 4 shows a block diagram of an apparatus for transmitting USB data in accordance with another exemplary embodiment of the present disclosure. The apparatus 400 for transmitting USB data comprises a wireless communication chip 401, an acquiring unit 402, a calculating unit 403, a transmitting unit 404, a determining unit 405 and a receiving unit 406. The wireless communication chip 401 is utilized to send at least one negative acknowledge packet, at least one acknowledge packet or at least one received data, or to receive at least one data to be sent. The acquiring unit 402 is utilized to obtain a size of a buffer and a transfer rate of the wireless communication chip 401. In accordance with an exemplary embodiment of the present disclosure, the buffer, for example, is a transmitting buffer. The calculating unit 403 is utilized to obtain at least one time interval in accordance with the size of the buffer and the transfer rate of the wireless communication chip 401. The transmitting unit 404 is utilized to send the at least one data to be sent to the wireless communication chip 401, or to send at least one PING packet or the at least one data to be sent to the wireless communication chip 401 in accordance with a determination result of the determining unit 405. The receiving unit 406 is utilized to receive the at least one negative acknowledge packet, the at least one acknowledge packet and the at least one received data, which are sent by the wireless communication chip 401. The determining unit 405 is utilized to determine whether the receiving unit 406 has received the at least one negative acknowledge packet or the at least one acknowledge packet. The at least one negative acknowledge packet, the at least one acknowledge packet, or the at least one received data, which are sent by the wireless communication chip 401, are received by the receiving unit 406 through, for example, a USB chip and a USB bus. The transmitting unit 404 sends the at least one data to be sent to the wireless communication chip 401, or sends the at least one PING packet or the at least one data to be sent to the wireless communication chip 401 in accordance with a determination result of the determining unit 405 through the USB chip and the USB bus. The above-mentioned acquiring unit 402, calculating unit 403, transmitting unit 404, determining unit 405 or receiving unit 406 is implemented with software, firmware, hardware, or a platform with a single processor or with multiple processors.

The method and apparatus of the present disclosure for transmitting USB data includes obtaining a time interval in accordance with a size of a buffer and a transfer rate of a wireless communication chip. After sending data to be sent to the wireless communication chip, if the wireless communication chip responds with a negative acknowledge packet, the data to be sent is re-sent to the wireless communication chip after the time interval. In addition, during the time interval, if a receiving buffer stores received data, the received data stored in the receiving buffer is received through the wireless communication chip, so as to increase the data throughput.

The above-described embodiments of the present disclosure are intended to be illustrative only. Numerous alternative embodiments may be devised by persons skilled in the art without departing from the scope of the following claims.

What is claimed is:

1. A method for transmitting universal serial bus (USB) data, the method comprising the steps of:
obtaining a time interval in accordance with a size of a buffer and a transfer rate of a wireless communication chip;
sending data to be sent to the wireless communication chip; and
re-sending the data to be sent to the wireless communication chip after the time interval if the wireless communication chip responds with a negative acknowledge packet.

2. The method of claim 1, further comprising the step of obtaining the size of the buffer.

3. The method of claim 1, further comprising the step of obtaining the transfer rate of the wireless communication chip.

4. The method of claim 1, further comprising the step of sending a packet internet grope (PING) packet to the wireless communication chip and receiving an acknowledge packet before re-sending the data to be sent to the wireless communication chip.

5. The method of claim 4, wherein the data to be sent and the PING packet are sent to the wireless communication chip through a USB chip and a USB bus.

6. The method of claim 5, wherein the acknowledge packet sent by the wireless communication chip is received through the USB chip and the USB bus.

7. The method of claim 1, further comprising the step of receiving a received data stored in a receiving buffer through the wireless communication chip in the time interval, if the received data has been stored in the receiving buffer.

8. The method of claim 1, wherein the buffer is a transmitting buffer.

9. An apparatus for transmitting universal serial bus (USB) data, the apparatus comprising:
a wireless communication chip configured to send at least one negative acknowledge packet, at least one acknowledge packet or at least one received data, or to receive at least one data to be sent;
a calculating unit configured to obtain at least one time interval in accordance with a size of a buffer and a transfer rate of a wireless communication chip;
a receiving unit configured to receive the at least one negative acknowledge packet, the at least one acknowledge packet and the at least one received data, which are sent by the wireless communication chip;
a determining unit configured to determine whether the receiving unit has received the at least one negative acknowledge packet or the at least one acknowledge packet; and
a transmitting unit configured to send the at least one data to be sent to the wireless communication chip, or to send at least one packet internet grope (PING) packet or the at least one data to be sent to the wireless communication chip in accordance with a determination result of the determining unit.

10. The apparatus of claim 9, further comprising an acquiring unit configured to obtain the size of the buffer and the transfer rate of the wireless communication chip.

11. The apparatus of claim 9, wherein the at least one negative acknowledge packet, the at least one acknowledge packet or the at least one received data are received by the receiving unit through a USB chip and a USB bus.

12. The apparatus of claim 11, wherein the transmitting unit sends the at least one data to be sent to the wireless communication chip or sends the at least one PING packet or the at least one data to be sent to the wireless communication chip in accordance with a determination result of the determining unit through the USB chip and the USB bus.

13. The apparatus of claim 9, wherein the buffer is a transmitting buffer.

14. The apparatus of claim 9, wherein the calculating unit, the receiving unit, the determining unit, the transmitting unit or the acquiring unit is implemented with software, firmware, hardware, or a platform with a single processor or with multiple processors.

15. The apparatus of claim 10, wherein the calculating unit, the receiving unit, the determining unit, the transmitting unit or the acquiring unit is implemented with software, firmware, hardware, or a platform with a single processor or with multiple processors.
